(19) United States
(12) Patent Application Publication
(10) Pub. No.: US 2019/0012751 A1
(43) Pub. Date: Jan. 10, 2019

(54) REAL-TIME, ELECTRONICALLY-EXECUTED CONSENT RECEIPT AND DOCUMENTATION SYSTEMS

(71) Applicant: Bank of America Corporation, Charlotte, NC (US)

(72) Inventors: Elizabeth S. Votaw, Potomac, MD (US); David J. Smiddy, Chadds Ford, PA (US); Fnu Sidharth, Charlotte, NC (US); James Alexander, Dripping Springs, TX (US)

(21) Appl. No.: 15/642,584

(22) Filed: Jul. 6, 2017

(51) Int. Cl. G06Q 50/18; G06F 19/00

(52) U.S. Cl. CPC G06Q 50/18; G06F 19/322

(57) ABSTRACT

Methods for receiving and documenting real-time, electronically-executed consent is provided. Methods may include initiating a human contact session between a first human entity and a second human entity. Methods may include transmitting a first request from a mobile device associated with the first human entity to a communications hub. The communications hub may transmit electronic documents and one or more electronic consent mechanisms to a mobile device associated with the second entity. The second entity may review the electronic documents and consent and/or agree to the information and/or requirements included in the electronic documents using one or more of the electronic consent mechanisms. Upon receipt of the consent and/or agreement at the communications hub, the communications hub may transmit an electronic notification of the received consent and/or agreement to the first human entity. The first human entity may continue the human contact session upon receipt of the agreement.

### FIELD OF TECHNOLOGY

This invention relates to obtaining electronic consent. Additionally, this invention relates to real-time documentation of the obtained electronic consent.

### BACKGROUND OF THE DISCLOSURE

An entity may require a prospective client or existing client to receive, review and consent and/or otherwise agree to information and/or requirements included in specific official and/or authorized documents. The entity may require receipt of the consent and/or agreement prior to an entity representative entering into a communication interaction with the client.

Conventionally, many entities use ad hoc methods to transmit the documents to the clients. For example, an entity representative may hand a client a stack of documents. The client typically reviews the documents and verbally consents and/or agrees to the information and/or requirements included in the documents. The entity representative usually records, in a non-electronic manner, the client's consent and/or agreement to the information and/or requirements included in the documents.

One example of a document requiring consent may be a HIPAA (Health Insurance Portability and Accountability Act) release document. Upon signing a HIPAA release document, the signer may authorize an entity to share and/or release specific personal information and/or documentation.

One example of a document requiring agreement may be a notice that a specific financial service is not Federal Deposit Insurance Corporation (FDIC) insured and may lose value. Upon signing the notice, the signer may make clear that he or she agrees to continue a discussion with a financial services advisor despite the fact that financial products offered may not be FDIC insured and may lose value.

At times, an entity may be required to show proof that a specific client did indeed consent or agree to an interaction and/or segment(s) of information included in a specific document. Obtaining proof of the consent and/or agreement may be difficult, if not impossible, when the consent was received and documented via ad hoc methods.

Therefore, systems and methods for receiving real-time, electronically-executed consent at a centralized consent portal, and documenting the received electronically-executed consent in the centralized consent portal may be desirable.

### SUMMARY OF THE INVENTION

A method is provided for receiving and documenting, in real-time, electronic consent and/or execution of an electronic agreement received from an entity. The method may be implemented during an ongoing human contact session between a first human entity and a second human entity.

The first human entity may initiate the human contact session with the second human entity. Upon initiation of the human contact session, the first human entity may transmit an electronic request to a centralized communications hub. The first human entity may be required to receive approval of the electronic request in order to maintain and/or continue the human contact session. The requirement to delay continuance and/or escalation of the human contact session until receipt of approval of the electronic request may increase security associated with the human contact session.

Prior to transmission of an approval communication, the centralized communications hub may transmit an electronic communication to the second entity, or a mobile device associated with the second entity. The electronic communication may include an electronic document. The electronic communication may also include an electronically selectable consent mechanism. The electronically selectable consent mechanism may be an electronic button designated for document consent. The electronic document and/or the electronically selectable consent mechanism may appear on the second entity's mobile device. The electronic document and/or the electronically selectable consent mechanism may be transmitted in a variety of different communication mechanisms, such as SMS, email, flash SMS or any other suitable communication method.

A short message service (“SMS”) message may be a text communication to or from a mobile device. An SMS may be transmitted over standardized communications protocols.

In some embodiments, a flash SMS may be desirable. A flash SMS may be a type of SMS that may appear directly on the main screen of a mobile device absent user interaction. A flash SMS may be not be automatically stored in the mobile device's inbox. A flash SMS may be particularly useful in preserving the confidentiality of the electronic communication.

A flash SMS comprising the electronic document and the electronically selectable consent mechanism may be transmitted to the second entity's mobile device. The electronic document and consent mechanism may appear on the face of the mobile device. Upon selection of the electronically selectable consent mechanism, or upon closure of the flash SMS message, or upon completion of a predetermined time period, the flash SMS may be deleted from the mobile device or not necessarily saved in a typical storage location of the mobile device, such as an inbox. Therefore, proprietary information included in the flash SMS, such as the electronic document, may not be viewable on the second entity's mobile device via typical channels. The second entity may be able to view the electronic document on a secured portal or other suitable secured location or other suitable communications channel.

By selecting the electronically selectable consent mechanism, the second entity may confirm his or her consent and/or agreement to information and/or authorizations included in the electronic document. A responsive electronic communication, including the timestamp of the selection of the electronically selection consent mechanism, may be transmitted from the second entity, or a mobile device associated with the second entity, to the centralized communications hub. The responsive electronic communication may be sent in response to the selection of the electronically selection consent mechanism. The responsive electronic communication may include a device identification number associated with the selection of the electronically selectable consent mechanism. The device identification number may be a unique mobile device identification number.

The centralized communications hub may be configured to transmit an electronic notification to the first entity. The transmission may be upon receipt of the responsive electronic communication at the centralized communications hub. The electronic notification may include approval of the electronic request to establish human contact.

Upon receipt of the approval, the first human entity may maintain and/or continue the ongoing human contact session between the first human entity and the second human entity.

It should be appreciated that the electronic communications may be documented at the centralized communications hub. The second entity, the first entity and/or any other suitable authorized user may view the electronic communications, including the electronic document and the timestamp of the selection of the electronically selectable consent mechanism, on a secured front-end electronic portal.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIGS. 1A and 1B show an illustrative diagram according to principles of the invention; and

FIG. 2 shows an illustrative diagram according to principles of the invention; and

FIG. 3 shows an illustrative diagram according to principles of the invention.

### DETAILED DESCRIPTION OF THE DISCLOSURE

Apparatus and methods is provided for receiving and documenting, in real-time, electronic consent and/or execution of an electronic agreement received from an entity. The method may include receiving, at a centralized communications hub, an electronic request from a first human entity. The request may be transmitted during an ongoing human contact session between the first human entity and a second human entity.

The method may include directing the second human entity to a non-secured webpage. The directing may be implemented via a hyperlink embedded in an email, SMS, flash SMS or other suitable electronic communication transmitted from the centralized communications hub to a mobile device associated with the second human entity.

In some embodiments, the email, SMS, flash SMS or other suitable electronic communication may self-delete upon selection of the hyperlink by the second entity. In other embodiments, the email, SMS, flash SMS or other suitable electronic communication may self-delete upon conclusion of a predetermined time period.

Upon selection of a hyperlink included in the electronic communication, the second entity may be directed to the non-secured webpage. The non-secured webpage may include electronic documents. The electronic documents may include information. The second entity may be required to consent and/or agree to the information included in the electronic documents. The non-secured webpage may also include one or more electronically selectable consent mechanisms.

Upon selection of the electronically selectable consent mechanism, the second entity may be directed to a secured webpage. The secured webpage may include mechanisms for retrieval and storage of identifying information relating to the second entity. In some embodiments, the mechanisms for retrieval may include a browser cookie.

The method may include storing the identifying information in the centralized communications hub. The method may include storing the electronic documents in the centralized communications hub. The method may include storing a timestamp of the selection of the consent mechanism in the centralized communications hub.

The method may include transmitting an electronic notification to the first entity. The electronic notification comprising an approval of the electronic request to maintain, continue and/or escalate the human contact session.

The method may include displaying the identifying information, the electronic documents and a timestamp of the selection of the electronically selectable consent mechanism in a portal. The portal may be designed for review of stored consent information. The portal may be secured. The consent information included in the portal may be mutable. The consent information included in the portal may be immutable. Portions of the consent information included in the portal may be mutable, while other portions of the consent information may be immutable.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

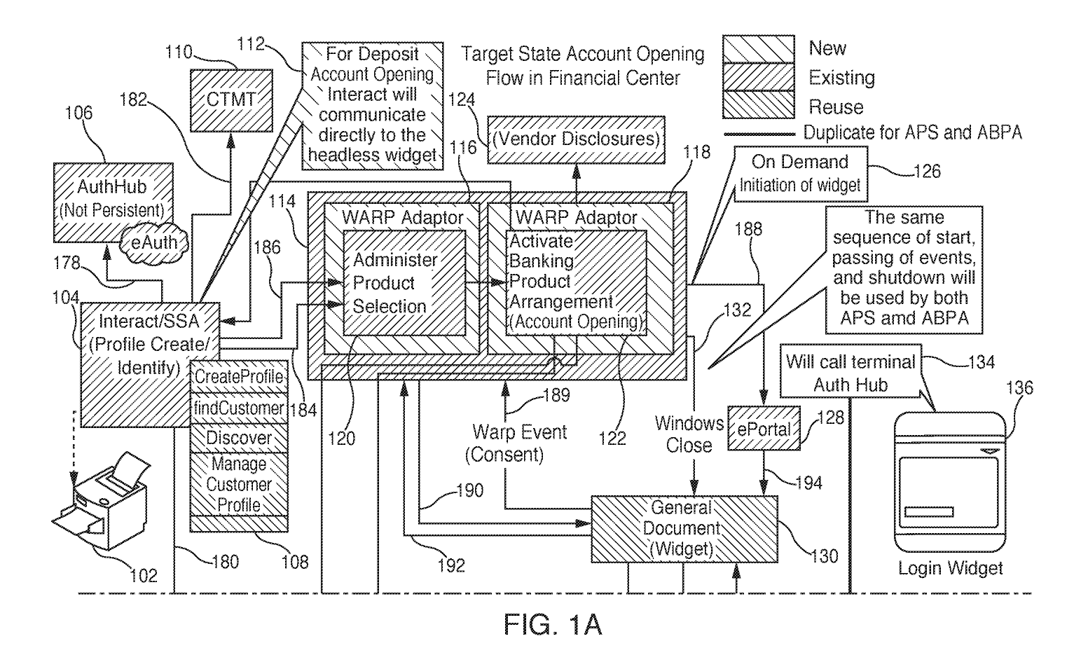

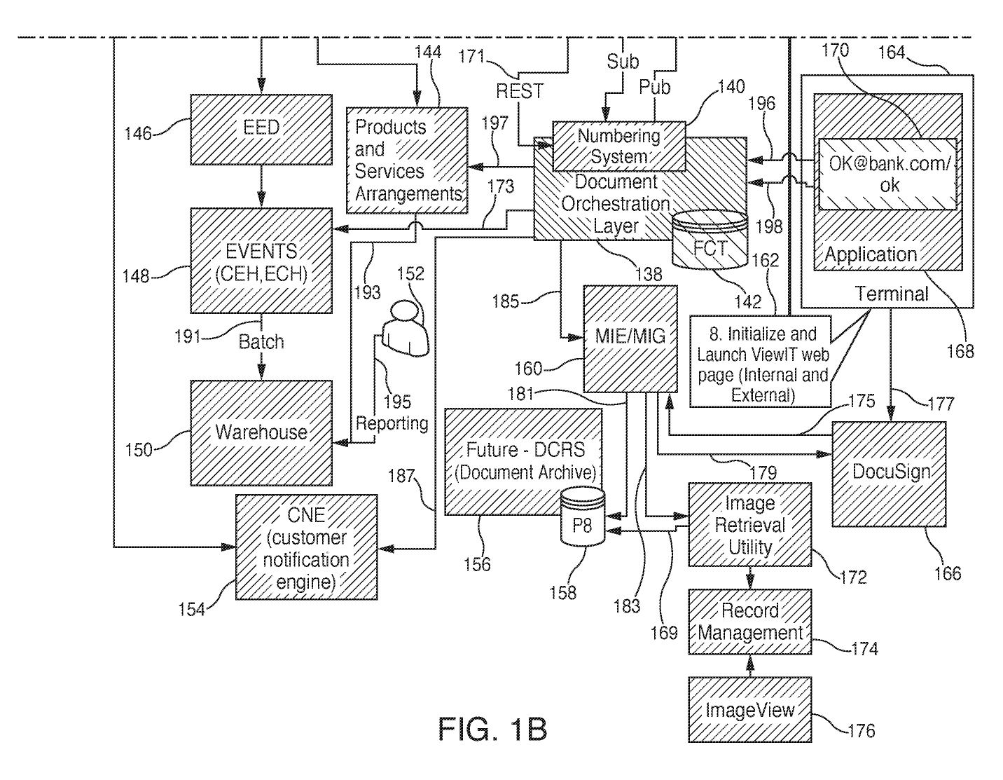

FIGS. 1A and 1B show a target state account opening flow in a financial center. A target state, for the purposes of this application, may be an ideal process flow.

At interaction 104, an interaction between an entity and a customer is initiated. Interaction 104 interaction may be initiated by the customer. Interaction 104 may be initiated by the entity. Interaction 104 may include completing a sales and service application (“SSA”). Interaction 104 may include creation of a profile for the customer. The profile may include information relating to the customer, such as name, address and phone number. The profile may include any accounts associated with the customer. The profile may also include biometric information relating to the customer. The biometric information may be used to authenticate a customer during the process flow. Interaction 104 may include identification of a profile for the customer. Interaction 104 may include executing one or more of operations 108.

Operations 108 may include methods steps which may be performed to initiate an interaction and/or subsequent to initiation of the interaction. Operations 108 may include tasks such as creating a profile, finding a customer, discover and manage a customer portal. During interaction 104, method steps may include communicating with physical hardware, such as printer 102.

Communication line 178 may link interaction 104 with authorization hub 106. Communication 178 may be conducted via Web Application Re-use Platform (“WARP”) events. Authentication hub 106 may authenticate the customer. Authentication hub 178 may operate in its own domain. Authentication hub 178 may provide an added layer of functionality by performing autonomously.

Using communication line 180, in the case of a digital authentication option, the customer associated with the login may be notified of the login attempt using customer notification engine (“CNE”) 154.

Communication line 182 links Module Channel Technology Mid-Tier (“CTMT”) 110 and interaction 104. CTMT 110 may generate one or more deposit forms. For example, CTMT 110 may generate a direct deposit form for a customer.

Communication line 184 links interaction 104 and administer product selection (“APS”) 120. Communication line 184 may transmit information generated during interaction 104 and thereby prime APS 120. Priming APS 120 may include utilizing data generated during interaction 104 to pre-populate APS 120. The data may include authentication data. The authentication data may have been received during interaction 104 from authentication hub 106 via communication line 178. In order to prime APS 120 a subroutine may be called and executed.

Communication line 186 may activate a banking product arrangement (“ABPA”) uniform resource locator (“URL”) at ABPA 122. Interaction 104 may trigger launch of the ABPA URL in a separate window at ABPA 122.

Communication line 188 may initiate a headless generate document widget 130. The document widget may generate consent documents. Generate document widget 130 may be generated two or more times. For example, a first instance of widget 130 may be generated for APS 120. A second instance of widget 130 may be generated for ABPA 122. The document generation may be performed at a portal, such as electronic portal, shown at 128. Callout 126 shows that widget 130 may be generated on-demand. Callout 112 shows that, when interaction 104 includes a deposit account opening, interaction 104 may include transmitting information directly to widget 130.

A general document or consent document generated by widget 130, may be transmitted to the customer via communication link 194 or communication link 190. The document may be transmitted via one or more WARP events. Communication link 192 shows that ABPA 122 may be informed of which document is needed from the customer. ABPA 122 may communicate directly with vendor disclosures 124.

As shown at 162, the customer may initialize and launch a ViewIT web page. The ViewIT webpage may be an internal webpage with respect to the hosting entity. The ViewIT webpage may be an external webpage with respect to the hosting entity. In some embodiments, the initialized webpage may be webpage 170. Webpage 170 may be resident in application 168 at terminal 164. Terminal 164 may be a virtual terminal, such as a mobile device terminal. Terminal 164 may be a physical terminal, such as a banking center, automated teller machine (“ATM”) or automated teller assist (“ATA”).

Application 168 may poll document orchestration layer 138 for new documents, using communication 196. The documents may include account application documents, consent document, release documents and any other suitable documents. The documents may include information and/or requirements that may require consent and/or agreement from a customer. Document orchestration layer 138 may transmit, or display a document, which may be included in database 142, to the customer, using application 168. Application 168 may be running on a mobile device of the customer. The customer may transmit consent to document displayed within application 168 using communication line 198. The customer may also transmit the document from application 168 to document orchestration layer 138. Document orchestration layer 138 may store the consent and/or the document associated with the consent. The storage may be in database 142.

Document orchestration layer 138 may communicate with general document widget 130 via numbering system 140. Numbering system 140 may number each document. Numbering each document may enable tracking, recording and retrieval of each document.

Document orchestration layer 138 may update products and services arrangements (“PSA”) 144 available to the customer based on the consent and/or the document associated with the consent. PSA 144 may be accessed through application 168. The recordation of a consent and associated document may utilize representational state transfer (“REST”) services, as shown at 171. Documentation orchestration layer 138 may log customer event hub/enterprise customer event hub (“CEH/ECH”) 148 regarding the transmitted consent and/or consented document, as shown at 173. The information associated with CEH/ECH 148 may be transmitted to data warehouse 150 in batch files, as shown at 191. PSA 144 and entity 152 may also transmit reporting information to data warehouse 150, using communications 195 and 193, respectively.

CEH/ECH events 148 may receive vendor disclosure information from enterprise event data store (“EED”) 146.

General document widget 130 may transmit a WARP event, including the consent, to WARP communications collaboration center 114 via communication line 189. The warp event may be directed to the calling application, which may be APS 120 or ABPA 122 using WARP adaptors 116 or 118, respectively. Document orchestration layer 138 may transmit a notification to customer notification entity 154, via communication 187. The notification may notify the customer, via e-mail, text or other suitable communication mechanism, regarding the WARP event and its success or failure. Windows close communication 132 may show that the same sequence of start, passing of events, and shutdown may be used by both APS and ABPA.

Login Widget 136 may be associated with terminal 164. Login Widget 136 may securely call terminal 164, as shown at 134.

Document orchestration layer 138 may create an environment or get a URL using communication 185 with Message Integration Engine/Mortgage Integration Gateway (MIE/MIG) 160. MIE/MIG 160 may direct Image retrieval utility 172 (which may be used for bulk check statement image retrieval utility supporting various delivery channels and products) to generate a consent document via communication 183. MIE/MIG 160 may transmit metadata to database 158, included in document archive 156, via metadata feed 181. MIE/MIG 160 may transmit metadata to docusign 166 via metadata feed 179. The customer may electronically sign the consent document at terminal 164. The electronic consent may be transmitted to docusign 166 via communication 177. DocuSign 166 may transmit the consent to MIE/MIG 160 via communication 175. Communication 175 may determine the completion of the consent document signing event. Image retrieval utility 172 may also transmit the completion of the consent to database 158, via communication 169.

Image retrieval utility 172 and image view 176 may transmit the consent document to record management 174.

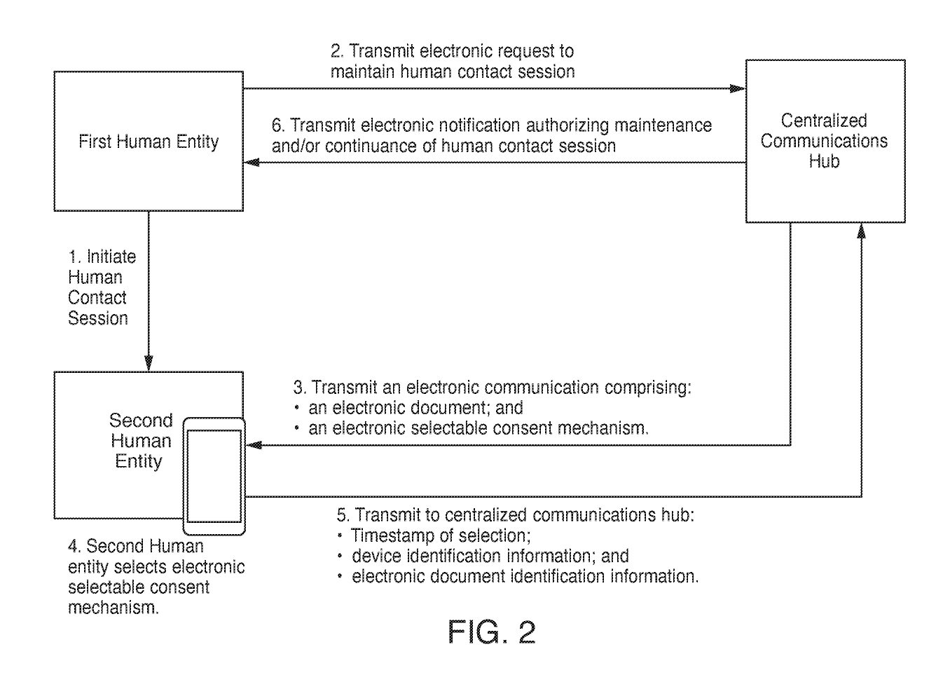

FIG. 2 shows an illustrative flow diagram. A first human entity may initiate a human contact session with a second human as shown at 202. The first human entity may also transmit an electronic request to a centralized communications hub to maintain the human contact session, as shown at 204.

The centralized communications hub may transmit an electronic communication to the second human entity, as shown at 206. The electronic communication may include an electronic document and an electronically selectable consent mechanism. The electronic communication may be transmitted to a mobile device associated with the second human entity.

The second human entity may select the electronically selectable consent mechanism. The second human entity and/or the mobile device associated with the second human entity may transmit a responsive electronic communication to the centralized communications hub, as shown at 208.

The responsive electronic communication may include a timestamp of the selection, the second entity's mobile device identification information and electronic document identification information. Upon receipt of the responsive electronic communication, the centralized communications hub may transmit an electronic notification to the first human entity, as shown at 210. The electronic notification may include authorization of maintenance and/or continuance of the human contact session.

It should be appreciated that transmissions to and from the first entity may be between an electronic medium, such as a mobile device, associated with the first entity.

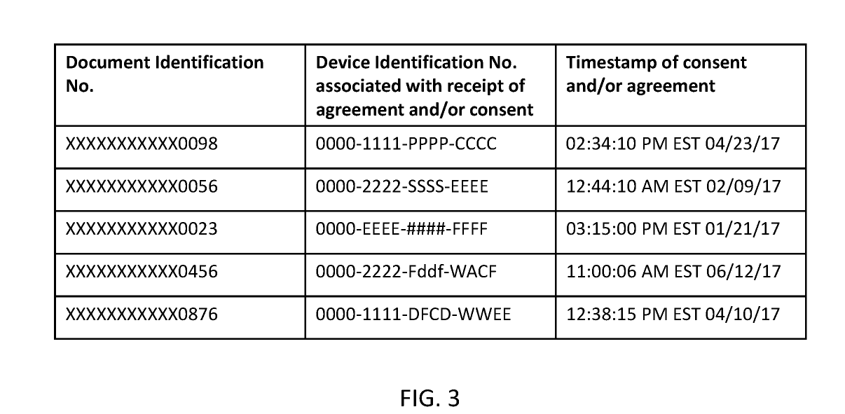

FIG. 3 shown an illustrative graphical user interface (“GUI”). The GUI may display a consent portal. The consent portal may be viewable by a specific user. The user may be an entity that consented and/or agreed to specific electronic documents. The user may be an entity associated with the communications hub.

It should be appreciated that a personal user—i.e., an entity that consented and/or agreed to specific electronic documents—may only be able to view his personal documents, while a communications hub user—i.e., a user associated with the entity that transmitted and manages the consent documents—may be able to view many documents that pertain to a variety of different users.

The consent portal may include an entry, or row, for each received consent. A row may include document identification information.

In some embodiments, the document identification number may be a hyperlink. A user, of the consent portal, may select the document identification number. Upon selection of the document identification number, the user may be directed to a webpage that includes a display of the electronic document.

A row may also include a device identification number. The device identification number may be the identification number of the device which originally transmitted the agreement and/or consent. The agreement and/or consent may have been transmitted by a process of a user selecting an electronically selectable consent mechanism.

A row may also include a timestamp of the consent and/or agreement. The timestamp displayed may be the timestamp that the second entity selected the electronically selectable consent mechanism associated with the electronic document.

In some embodiments, a user may be able to remove his or her consent, using a delete option (not shown), from a portion of the documents displayed. Some of the documents may allow the user to delete the consent and/or agreement, while other documents may not allow the user to delete the consent and/or agreement. At times, the capability to delete the consent and/or agreement may be based on the current applicability of the document.

Thus, methods and apparatus for real-time, electronically-executed consent receipt and documentation systems are provided. Persons skilled in the art will appreciate that the present invention can be practiced by other than the described embodiments, which are presented for purposes of illustration rather than of limitation, and that the present invention is limited only by the claims that follow.

1. A method for receiving and/or documenting electronic consent and/or execution of an electronic agreement received in real-time, the method comprising:
during an ongoing human contact session between a first human entity and a second human entity, receiving, at a centralized communications hub, an electronic request from the first entity to augment a security level associated with human contact session;
transmitting, from the centralized communications hub, an electronic communication to the second entity, the electronic communications comprising:
an electronic document; and
an electronically selectable consent mechanism;
transmitting a responsive electronic communication to the centralized communications huh, said responsive electronic communication comprising:
a timestamp of the selection of the electronically selectable consent mechanism,
a device identification number associated with the selection of the electronically selectable consent mechanism; and
an electronic document identification number, in response to:
the second entity receiving the electronic communication; and
the second entity selecting the electronically selectable consent mechanism.

2. The method of claim 1, wherein the electronic communication is an SMS (“short message service”) message.

3. The method of claim 2, wherein the SMS is a flash SMS.

4. The method of claim 2, wherein the SMS message is received from an email address.

5. The method of claim 1, wherein, upon receipt of the responsive electronic communication at the centralized communications hub, the centralized communications hub is configured to transmit an electronic notification to the first entity, said electronic notification comprising approval of the electronic request to establish human contact.

6. The method of claim 5, wherein the centralized communications hub is configured to store the responsive electronic communication in a portal designed for review and display of a record associated with the responsive electronic communication.

7. The method of claim 6, wherein the second entity may review the responsive electronic communication on the portal.

8. The method of claim 7, wherein the responsive electronic communication is determined to be mutable, and therefore, the second entity may retract its consent via the portal.

9. The method of claim 7, wherein the responsive electronic communication is determined to be immutable, and therefore, the portal may display the permanency of the consent.

10. A method for receiving and/or documenting electronic consent and/or execution of an electronic agreement received in real-time, the method comprising:
during an ongoing human contact session between a first human entity and a second human entity, receiving, at a centralized communications hub, an electronic request from the first entity to maintain the human contact session;
directing the second entity to a non-secured webpage, said non-secured webpage being associated with the world-wide-web, said non-secured webpage comprising:
electronic documents that includes information that anticipate consent and/or agreement by the second entity; and
an electronically selectable consent mechanism;
upon selection of the electronically selectable consent mechanism by the second entity, directing the second entity to a secured webpage, said secured webpage for retrieval and storage of identifying information relating to the second entity;
storing the identifying information, the electronic documents and a timestamp of the selection of the electronically selectable consent mechanism in a centralized communications hub; and
transmitting an electronic notification to the first entity, said electronic notification comprising an approval of the electronic request to maintain the human contact session.

11. The method of claim 10, wherein the directing is via a selectable link emailed to a mobile device associated with the second entity.

12. The method of claim 10, wherein the directing is via a selectable link communicated via SMS (“short message service”) to a mobile device associated with the second entity.

13. The method of claim 12, wherein, the method further comprises displaying the identifying information, the electronic documents and a timestamp of the selection of the electronically selectable consent mechanism in a portal designed for review of stored consent information.

14. The method of claim 13, wherein the second entity may review the responsive electronic communication on the portal.

15. The method of claim 14, wherein:
when the selection of the consent button is determined to be mutable, the second entity may retract its consent via the portal; and
when the selection of the consent button is determined to be immutable, the second entity may view the permanency of the consent via the portal.

16. An apparatus for receiving and/or documenting electronic consent and/or execution of an electronic agreement received in real-time, the apparatus comprising:
a receiver configured to receive, during an ongoing human contact session between a first human entity and a second human entity, an electronic request to maintain the human contact session;
a transmitter configured to transmit an electronic communication to the second entity, the electronic communication comprising:
an electronic document; and
an electronically selectable consent mechanism;
the receiver further configured to receive a responsive electronic communication in response to the second entity's selection the electronically selectable consent mechanism, the responsive electronic communication comprising:
a timestamp of the selection of the consent button;
a device identification number associated with the selection of the consent button; and
an electronic document identification;
the transmitter further configured to transmit an electronic notification to the first entity upon receipt of the responsive electronic communication, the electronic notification comprising an approval of the electronic request to establish human contact.

17. The apparatus of claim 16, wherein the electronic communication is:
a short message service (“SMS”);
a flash SMS; or
an email notification.

18. The apparatus of claim 17, wherein the electronic communication includes a selectable link, and wherein, upon selection of the selectable link by the second entity, the second entity may be directed to an unsecured website comprising consent documentation.
